(19) United States
(12) Patent Application Publication
(10) Pub. No.: US 2026/0237708 A1
(43) Pub. Date: Aug. 13, 2026

(54) RECHARGEABLE CARBON BATTERY WITH FINISHING STACK

(71) Applicant: NOON ENERGY, Palo Alto, CA (US)

(72) Inventors: Theis L. SKAFTE, Palo Alto, CA (US); Sunjay G. MELKOTE, Sunnyvale, CA (US); Pawel A. PIOTROWICZ, Santa Clara, CA (US); Christopher Ronald GRAVES, Palo Alto, CA (US); Usama SOHAIL, Mountain View, CA (US); Jonathan W.H. WU, Los Angeles, CA (US)

(21) Appl. No.: 19/538,539

(22) Filed: Feb. 12, 2026

Related U.S. Application Data
(60) Provisional application No. 63/757,634, filed on Feb. 12, 2025.

(51) Int. Cl. H01M 8/18; B01D 53/02; C25B 1/23; H01M 8/04082; H01M 8/12; H01M 8/1231; H01M 12/08

(52) U.S. Cl. CPC H01M 8/186; C25B 1/23; H01M 8/04201; H01M 8/1231; H01M 12/08; B01D 53/02; B01D 2256/22; B01D 2257/502; H01M 2008/1293

(57) ABSTRACT

Set forth herein are solid-oxide electrochemical cells (SOC) that are configured with thermochemical reactors as carbon-oxygen batteries. The SOCs are, in various embodiments, capable of operating in discharge mode to provide a gas that maximizes the amount of carbon dioxide CO₂ and minimizes the amount of carbon monoxide CO prior to storing the gas.

### CROSS-REFERENCE TO RELATED APPLICATIONS

This application claims priority to, and the benefit of, U.S. Provisional Patent Application No. 63/757,634, filed Feb. 12, 2025, the entire contents of which are herein incorporated by reference in its entirety.

### FIELD

The present disclosure concerns solid-oxide electrochemical cells (SOCs) that are configured with thermochemical reactors as carbon-oxygen batteries.

### BACKGROUND OF THE INVENTION

When discharging a carbon-oxygen battery, carbon is oxidized to CO using CO₂, in a gasification process, in a thermochemical reactor (so-called carbon collector, CC). The CO in turn is oxidized to CO₂ in a solid oxide electrochemical cell (SOC) stack(s). The net CO₂ product is then stored for later use (during charging) in a CO₂ tank. Pure CO₂ may be stored to avoid unnecessarily taking up volume with CO in the CO₂ tank, which would require increasing the tank size. Storing CO would be inefficient since CO would not be needed during charging and CO requires additional energy to cool and compress it. This lowers the efficiency of the system. Lastly, storing CO could potentially cause safety concerns as it is toxic and flammable.

What is needed are methods to electrochemically separate CO from CO₂ that is generated in a SOC. What is needed are processes and systems that require minimal additional equipment, energetically passive components like valves and additional tubing, or combinations thereof.

Set forth herein are solutions to this and other problems in the instant field to which the present disclosure pertains.

### SUMMARY OF THE INVENTION

In one embodiment, set forth herein is a process that includes flowing a first gas that includes carbon monoxide (CO) and carbon dioxide (CO₂) to a main solid-oxide cell (SOC) stack; oxidizing the CO in the first gas in the main SOC stack to provide a second gas that include CO and CO₂ wherein the second gas has a lower partial pressure of CO (pCO) than the first gas; and flowing the first gas to a finishing SOC stack; oxidizing the CO in the first gas in the finishing SOC to provide a third gas wherein the third gas has a lower pCO than the second gas.

In a second embodiment, set forth herein is a process that includes: flowing a first gas that comprises carbon monoxide (CO) and carbon dioxide (CO₂) to a main solid-oxide cell (SOC) stack; oxidizing the CO in the first gas in the main SOC stack to provide a second gas that comprises CO and CO₂ wherein the second gas has a lower partial pressure of CO (pCO) than the first gas; flowing the second gas to a finishing SOC stack; and oxidizing the CO in the second gas in the finishing SOC to provide a third gas wherein the third gas has a lower pCO than the second gas.

In a third embodiment, set forth herein is a process that includes: flowing a first gas that comprises carbon monoxide (CO) and carbon dioxide (CO₂) to a solid-oxide cell (SOC) stack; oxidizing the CO in the first gas in the SOC stack to provide a second gas that comprises CO and CO₂ wherein the second gas has a lower partial pressure of CO (pCO) than the first gas; separating the second gas into a third gas and a fourth gas; wherein the fourth gas has a lower partial pressure CO (pCO) than the third gas; flowing third gas to a thermochemical reactor; and storing the fourth gas.

In a fourth embodiment, set forth herein is a system or apparatus for implementing a process described herein.

### BRIEF DESCRIPTION OF DRAWINGS

FIG. 1 shows an embodiment of a simplified system diagram with electrochemical separation of CO and CO₂, showing discharging on the left and charging on the right.

FIG. 2 shows another embodiment of a system diagram with electrochemical separation of CO and CO₂, showing discharging on the left and charging on the right.

FIG. 3 shows another embodiment of a simplified system diagram with electrochemical separation of CO and CO₂, showing discharging on the left and charging on the right.

FIG. 4 shows a plot of partial carbon monoxide pressure as a function of time (hours) at the outlet of the SOC stack.

FIG. 5 shows a plot of cell voltage (V) as a function of time (hours) at the finishing stack of the solid-oxide cell (SOC) stack.

FIG. 6 shows a Nyquist plot of impedance for a series of runs as described in Example 1.

FIG. 7 shows a plot of impedance as a function of Testing time (hours) showing the change in stack resistance.

FIG. 8 shows a plot of partial carbon monoxide pressure as a function of time (hours) at the finishing stack of the SOC stack.

### DETAILED DESCRIPTION OF THE INVENTION

Set forth below are processes and systems for separating CO and CO₂ in a carbon-oxygen battery that includes solid-oxide cell stacks and a thermochemical reactor.

### Definitions

As used herein, the term “about,” when qualifying a number, e.g., 15% by mol, refers to the number qualified and optionally the numbers included in a range about that qualified number that includes ±10% of the number. For example, about 15% by mol includes 15% by mol as well as 13.5% by mol, 14% by mol, 14.5% by mol, 15.5% by mol, 16% by mol, or 16.5% by mol. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein, the phrase “Boudouard threshold,” means the partial pressure of carbon monoxide, above which carbon is deposited and carbon dioxide is produced and below which carbon reacts with carbon dioxide to produce more carbon monoxide. The Boudouard threshold is a function of temperature and pressure and will change with increases or decreases in temperature and pressure.

As used herein, the phrase “partial pressure of carbon monoxide (pCO),” refers to the proportional amount of CO in a mixture of gases that include CO. For example, if a gas includes 50% CO by mole (by mol) and 50% CO₂ by mol, the partial pressure of CO would be 0.5 atm assuming 1 atm in total pressure.

As used herein, the phrase “Boudouard equilibrium pressure of carbon monoxide (pCO_{eq}),” refers to the partial pressure of CO at which the rate of carbon deposition equals the rate of carbon gasification.

As used herein, the phrase “gasifying carbon,” or “gasifying carbon from the Boudouard catalyst” refers to the process by which solid carbon on a Boudouard reaction catalyst reacts thermo-catalytically with CO₂ to form CO. Gasifying carbon includes the oxidation of carbon.

As used herein, the phrase “carbon-oxygen battery,” means a system or device for storing energy and for producing electrical energy when the carbon-oxygen battery is discharged. As used herein, a carbon-oxygen battery stores energy in the form of solid carbon and either liquid or vapor carbon dioxide. The battery is capable of generating electricity by combining the carbon and carbon dioxide to provide carbon monoxide that reacts electrochemically with oxygen in a solid-oxide fuel cell to generate electricity. The battery is capable of being charged by supplying the battery electricity to reverse the chemical processes. An example carbon-oxygen battery is disclosed in U.S. Pat. No. 9,780,424 B2, which issued Oct. 3, 2017, the entire contents of which are herein incorporated by reference in its entirety for all purposes.

As used herein, the phrase “closed loop,” means that the system is closed and not exposed or open to the environment, and such that the gases in the loop remain in the loop. The gases, such as CO and CO₂ may flow from or to the thermochemical reactor, main stack, finishing stack, or storage tank, but may not exit the system.

As used herein, the phrase “closed system” refers to an energy storage system where no fuel enters or exits the battery. The only thing going in/out is electricity during charge/discharge and oxygen (O₂) to/from the atmosphere. O₂ enters during discharge mode and O₂ exits during charge mode. All of the chemical reagents and/or products, other than oxygen, are stored within a closed system.

As used herein, the term “cryo-separation,” refers to process by which a gas comprising more than one type of molecule is cooled so that different types of molecules may be separated from each other.

As used herein, the phrase “cryogenic separator,” refers to a device that is useful for performing cryo-separation.

As used herein, the phrase “main SOC stack,” refers to a solid-oxide cell stack, as defined below, that works in combination with another SOC stack, such as a finishing SOC stack. The main SOC stack differs from the other SOC stack, in which it operates in combination, with respect to the percent conversion of CO to CO₂; the number of SOC cells, the voltage applied to the main stack; the operating temperature of the stack, the flow rate of gases through the stack; or a combination thereof. A main SOC stack converts a lower percent of CO to CO₂ than does a finishing stack.

As used herein, the phrase “finishing SOC stack” refers to a solid-oxide cell stack, as defined below, that works in combination with another SOC stack, such as a main SOC stack. The finishing SOC stack differs from the other SOC stack, in which it operates in combination, with respect to the percent conversion of CO to CO₂; the voltage applied to the main stack; the number of SOC cells, the operating temperature of the stack, the flow rate of gases through the stack; or a combination thereof. A finishing SOC stack converts a higher percent of CO to CO₂ than does a main stack.

As used herein, the phrase “oxidizing the CO,” refers to a catalytic process in a solid-oxide cell in which CO converts to CO₂. Oxidizing the CO is synonymous with reacting the CO such that the CO forms CO₂.

As used herein, the phrase “pressure swing” or “temperature swing,” refers to two ways of separating gases from each other. A pressure swing is a process by which a gas having more than one type of constituent molecule is pressurize as it passes over some substrate that selectively absorbs one type of constituent molecule more than another. For example, membranes, zeolites, molecular sieves, and activated carbon are typical substrates. A gas comprising CO and CO₂ may flow over such a substrate under pressure. As the substrate selectively absorbs either CO or CO₂, the gas that flows away from the substrate is enriched with respect to the gas that is not absorbed. A temperature swing is a process by which two gaseous constituents are separated using temperature. For example, a gas comprising CO and CO₂ may be cooled to the point where CO₂ liquefies but the CO does not. By removing the gaseous CO from the liquified CO₂, the CO₂ can be purified and separated from CO.

As used herein, the phrase “rate of carbon gasification,” means the rate by which carbon catalytically reacts with carbon dioxide and generates carbon monoxide.

As used herein, the phrase “solid-oxide cell stack,” refers to a stack of electrochemical devices. Each electrochemical device has a positive electrode, a negative electrode, and an electrolyte between the positive electrode and negative electrode that is made of a solid oxide material. The negative electrode catalyzes the electrochemical oxidation of chemical reagents to produce electricity. The electrolyte conducts oxygen anions from one electrode to the other. An electrical conductor is placed between each electrochemical device to provide a stack of electrochemical devices. The electrical conductor conducts the electricity generated by the solid-oxide cell and combines the electricity generated by connected cells.

As used herein, the phrase “Boudouard catalysts,” is a material that catalyzes the Boudouard reaction. Boudouard catalysts include, but are not limited to, nickel, iron, and cobalt metals.

As used herein, the phrase “solid-oxide cell catalyst,” is a material in the fuel cell negative electrode that catalyzes the oxidation of CO in a stack or that catalyzes the reduction of CO₂ in a stack. Solid-oxide cell catalyst materials include, without limitation, nickel, often in combination with yttria-stabilized zirconia.

As used herein, the phrase “separating membrane,” refers to a membrane that is useful for separating the constituent gases in a gas stream that includes more than one type of gas. A separating membrane may selectively permeate one type of constituent gas molecule over another allowing one gas molecule to flow away from the absorbed gas. A separating membrane may include pores of a certain size that only allow one type of constituent gas molecule to flow through the membrane, thereby allowing one gas molecule to flow away from the gas molecules that are too large to pass through the pores.

As used herein, the phrase “thermochemical reactor,” means a reactor that includes catalysts suitable for performing the Boudouard reaction.

As used herein, a “reversible solid-oxide electrochemical cell (rSOC)” is a solid oxide cell that generates electricity in fuel cell mode and that uses electricity to generate a fuel product in electrolyzer mode. The rSOC operates reversibly in fuel cell mode and in electrolyzer mode depending on whether electricity is flowing out of or into the solid oxide cell, respectively. An example rSOC is found in U.S. Pat. No. 11,876,269, PASSIVE FLOW BATTERY, which issued Jan. 16, 2024, the entire contents of which are herein incorporated by reference in its entirety.

### Parallel Use of a Main Solid-Oxide Cell Stack and a Finishing Solid-Oxide Cell Stack

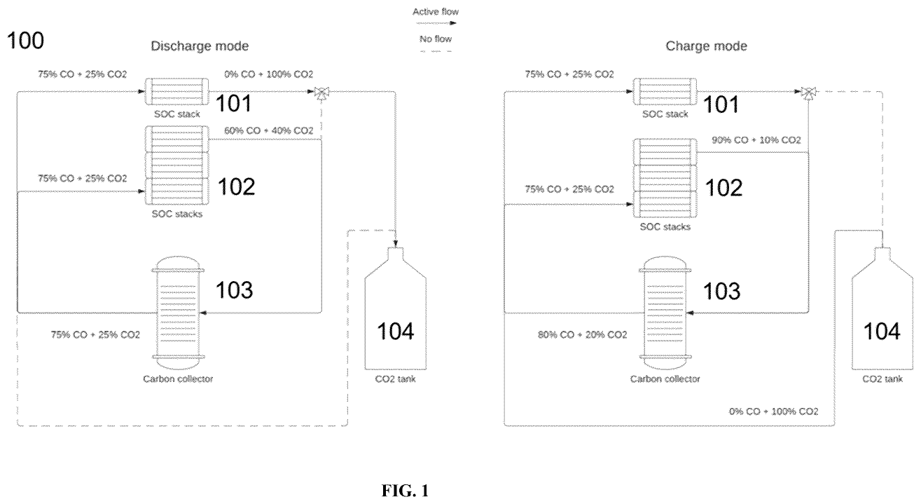

FIG. 1 shows an embodiment of a system for separating CO and CO₂. The system can operate in both discharge mode (shown on the left side) and in charged mode (shown on the right side). In the discharge mode, a carbon collector reactor, 103, which is also referred to herein as a thermochemical reactor, produces a gas stream. In certain embodiments, this gas stream includes about 75% by mol CO and about 25% by mol CO₂. Percents herein are mole percents unless specified otherwise to the contrary. Depending on how the thermochemical reactor is operated, different percents of CO and CO₂ are possible. This gas stream that exits the thermochemical reactor flows to two solid-oxide cell (SOC) stacks, a main SOC stack (102) and a finishing SOC stack (101). In some embodiments, the main SOC stack and the finishing SOC stack are physically separated. Herein, the flow of a gas stream may be passive or may be active. When active, the flow may be assisted or provided by using pumps, compressors, vacuum systems, or a combination thereof. In FIG. 1, the main SOC stack (102) is shown as having more total SOC stacks than the finishing SOC stack (101). The number of cells in each stack and the number of stacks in the main stack or in the finishing stack may vary. For example, the number of cells in each stack may range from 1 to 100 cells, from 1 to 250 cells, or 1 to 300 cells. The main stack may include more than 1 stack, for example, the main stack may include 1 to 10 stacks, wherein the stack may include 1 to 300 cells per stack. However, other embodiments are contemplated herein. The main difference between the main SOC stack (102) and the finishing SOC stack (101) is the extent to which CO is converted to CO₂ during discharge mode. The finishing SOC stack (101) converts more CO to CO₂, as a percent of the gas flowing therethrough, than the main SOC stack (102). The main SOC stack (102) and the finishing SOC stack (101) may have the same number of stacks or a different number of stacks. As shown in FIG. 1, the gas stream that includes about 75% by mol CO and about 25% by mol CO₂ flows to a main SOC stack (102) in which the CO is oxidized. This oxidation process also produces electricity in the main SOC stack (102) that can be used to run external devices. As the gas stream that includes about 75% by mol CO and about 25% by mol CO₂ is oxidized, the main SOC stack (102) then produces a second gas stream that includes about 60% by mol CO and about 40% by mol CO₂—the so-called second gas stream. Depending on how the main SOC stack (102) is operated, different percents of CO and CO₂ are possible. Generally, the second gas will have less CO and more CO₂ than the first gas since CO in the first gas is converted into CO₂ in the second gas. A portion of the gas stream that exits the thermochemical reactor (103) flows to the finishing SOC stack (101). As shown in FIG. 1, a portion of the gas stream that includes about 75% by mol CO and about 25% by mol CO₂ flows to a finishing SOC stack (101) in which the CO is oxidized. A larger fraction of the CO is oxidized in the finishing SOC stack (101) than in the main SOC stack (102). In some embodiments, this is because the flow rate in the finishing SOC stack (101) is lower than the flow rate in the main SOC stack (102), thereby increasing the conversion rate in the finishing SOC stack as compared to the main SOC stack. In some other embodiments, this is because of the voltage and current at which the finishing SOC stack (101) is operated. In some embodiments, the voltage is lower and the current is higher in the finishing stack than in the main SOC stack. In some embodiments, the finishing SOC stack (101) oxidizes all of the CO in the portion of the gas stream from the thermochemical reactor, e.g., the gas stream in FIG. 1 that includes about 75% by mol CO and about 25% by mol CO₂. In these embodiments, what exits the finishing SOC stack (101) is a gas stream—a so-called third gas stream-that includes 0% by mol CO and 100% by mol CO₂. This third gas stream that exits the finishing SOC stack (101) is then stored in a CO₂ storage tank (104). In certain embodiments, the gas stream that exits the main SOC stack, which is shown in FIG. 1 as a gas stream that includes the about 60% by mol CO and about 40% by mol CO₂, flows back to the thermochemical reactor.

In some other embodiments, gas stream that includes the about 60% by mol CO and about 40% by mol CO₂ is sent to a separation mechanism that separates CO₂ and flows this separated CO₂ into the CO₂ storage tank (104). This separation process is not shown in FIG. 1 but is contemplated herein.

In FIG. 1, the triangle shapes represent values and connections between gas conduit lines. These valves may be opened or closed to adjust the flow paths shown in FIG. 1.

FIG. 1 shows on the right side how the immediately above process and system works under charging conditions. In charging mode, CO₂ exits or flows from the CO₂ storage tank (104). The CO₂ then flows to the main SOC (102) stack where electricity is supplied to the main SOC stack (102) to reduce the CO₂ and form CO. The CO₂ from the CO₂ tank may also flow to the finishing SOC stack (101) where electricity is supplied to the finishing SOC stack (101) to reduce the CO₂ and form CO. FIG. 1 shows that the gas that exits the main SOC stack (102) in charge mode includes about 90% by mol CO and 10% by mol CO₂. Although not explicitly shown in FIG. 1, the gas that exits the finishing SOC stack (101) in charge mode may also include about 90% by mol CO and 10% by mol CO₂. Other percents of CO and CO₂ are possible depending on how the main SOC stack (102) and/or the finishing SOC stank (101) are operated. The gas stream that exits the main SOC stack (102) then flows to the carbon collector (103) where the Boudouard reaction occurs and the CO reacts to form solid C and generate CO₂. The gas stream that exits the finishing SOC stack (101) also then flows to the carbon collector (103) where the Boudouard reaction occurs and the CO reacts to form solid C and more CO₂. What exits the carbon collector (103) has more CO than the gas that flows from the CO₂ tank. In some embodiments, the gas that exits the carbon collector (103) includes about 80% by mol CO and 20% by mol CO₂.

The numbers in FIG. 1 depend on how much gas is flowing from the carbon collector and from the CO₂ tank. If, for example, the gas stream coming from the carbon collector has many more molecules than the gas from the CO₂ tank, then a mixture of 80%/20% CO/CO₂, from the carbon collector, and 0%/100% CO/CO₂, from the CO₂ tank, can equal 75%/25% CO/CO₂, entering the SOC stacks. Different ratios are possible depending on how the reactors are operated.

When the system in FIG. 1 operates in charge mode, electricity is supplied to the main SOC stack (102) as compared to the above-described discharge mode in which electricity is produced from the main stack. When the main SOC stack (102) or finishing SOC stack (101) are supplied electricity, CO₂ is reduced to form CO. When the main SOC stack (102) or finishing SOC stack (101) produce electricity, CO is oxidized to form CO₂. During charge mode, CO reacts in the thermochemical reactor to deposit carbon and produce CO₂. During discharge mode, CO₂ reacts in the thermochemical reactor with carbon to produce CO.

In some embodiments, set forth herein is a process that includes flowing a first gas that includes carbon monoxide (CO) and carbon dioxide (CO₂) to a main solid-oxide cell (SOC) stack; oxidizing the CO in the first gas in the main SOC stack to provide a second gas that include CO and CO₂ wherein the second gas has a lower partial pressure CO (pCO) than the first gas; and flowing the first gas to a finishing SOC stack; oxidizing the CO in the first gas in the finishing SOC to provide a third gas wherein the third gas has a lower pCO than the second gas.

In some embodiments, including any of the foregoing, the process includes storing the third gas. Depending on certain conditions, the third gas may be stored with the assistance of a compressor, cooling device, or both.

In some embodiments, including any of the foregoing, the first gas is provided from a thermochemical reactor. The thermochemical reactor (also known as a carbon collector) is a reactor designed for the Boudouard reaction to occur therein. The Boudouard reaction is a catalyst-assisted reaction in which 2 molecules of carbon monoxide are converted into 1 molecule of carbon dioxide and 1 atom of carbon, respectively. The process is reversible and can be used to form two molecules of carbon monoxide by combining 1 molecule of carbon dioxide and one atom of carbon. The process is represented by the chemical reaction 2CO↔CO₂+C. A variety of known catalysts are used to catalyze the Boudouard reaction.

In some embodiments, including any of the foregoing, the main SOC stack, finishing SOC stack, and thermochemical reactor are in a closed loop. A closed loop means that the system is closed such that the gases in the loop remain in the loop. The gases, such as CO and CO₂ may flow from or to the thermochemical reactor, main stack, finishing stack, or storage tank, but may not exit the system.

In some embodiments, including any of the foregoing, the process includes a storage tank in the closed loop.

In some embodiments, including any of the foregoing, the first gas, second gas, and third gas flow in the closed loop.

As noted above, the Boudouard reaction occurs inside the thermochemical reactor. When CO is formed, carbon gasification occurs so that the carbon may react with carbon dioxide. Carbon gasification is the process by which carbon, deposited or disposed on a Boudouard reaction catalyst is volatilized and reacts with CO₂ in contact therewith. In some embodiments, including any of the foregoing, the rate of storage of the third gas matches the rate of carbon gasification in the thermochemical reactor.

In some embodiments, including any of the foregoing, the first gas includes 20% to 80% by mol CO. In some other embodiments, including any of the foregoing, the first gas includes 30% to 70% by mol CO. In certain embodiments, the first gas includes 20% by mol CO, 25% by mol CO, 30% by mol CO, 35% by mol CO, 40% by mol CO, 45% by mol CO, 50% by mol CO, 55% by mol CO, 60% by mol CO, 65% by mol CO, 70% by mol CO, 75% by mol CO, or 80% by mol CO. In certain other embodiments, the first gas includes 20% by mol CO, 21% by mol CO, 22% by mol CO, 23% by mol CO, 24% by mol CO, 25% by mol CO, 26% by mol CO, 27% by mol CO, 28% by mol CO, 29% by mol CO, 30% by mol CO, 31% by mol CO, 32% by mol CO, 33% by mol CO, 34% by mol CO, 35% by mol CO, 36% by mol CO, 37% by mol CO, 38% by mol CO, 39% by mol CO, 40% by mol CO, 41% by mol CO, 42% by mol CO, 43% by mol CO, 44% by mol CO, 45% by mol CO, 46% by mol CO, 47% by mol CO, 48% by mol CO, 49% by mol CO, 50% by mol CO, 51% by mol CO, 52% by mol CO, 53% by mol CO, 54% by mol CO, 55% by mol CO, 56% by mol CO, 57% by mol CO, 58% by mol CO, 59% by mol CO, 60% by mol CO, 61% by mol CO, 62% by mol CO, 63% by mol CO, 64% by mol CO, 65% by mol CO, 66% by mol CO, 67% by mol CO, 68% by mol CO, 69% by mol CO, 70% by mol CO, 71% by mol CO, 72% by mol CO, 73% by mol CO, 74% by mol CO, 75% by mol CO, 76% by mol CO, 77% by mol CO, 78% by mol CO, 79% by mol CO, or 80% by mol CO.

In some embodiments, including any of the foregoing, the third gas includes at least 70% by mole CO₂. In some embodiments, including any of the foregoing, the third gas includes at least 80% by mole CO₂. In some embodiments, including any of the foregoing, the third gas includes at least 90% by mole CO₂. In some embodiments, including any of the foregoing, the third gas consists of 100% by mole CO₂.

In some embodiments, including any of the foregoing, the third gas includes 70% by mole (by mol) CO₂. In certain other embodiments, the third gas includes 70% by mol CO₂, 71% by mol CO₂, 72% by mol CO₂, 73% by mol CO₂, 74% by mol CO₂, 75% by mol CO₂, 76% by mol CO₂, 77% by mol CO₂, 78% by mol CO₂, 79% by mol CO₂, 80% by mol CO₂, 81% by mol CO₂, 82% by mol CO₂, 83% by mol CO₂, 84% by mol CO₂, 85% by mol CO₂, 86% by mol CO₂, 87% by mol CO₂, 88% by mol CO₂, 89% by mol CO₂, 90% by mol CO₂, 90% by mol CO₂, 91% by mol CO₂, 92% by mol CO₂, 93% by mol CO₂, 94% by mol CO₂, 95% by mol CO₂, 96% by mol CO₂, 97% by mol CO₂, 98% by mol CO₂, 99% by mol CO₂, or 100% by mol CO₂.

In some embodiments, including any of the foregoing, the third gas includes 0% to 30% by mol CO. In some other embodiments, including any of the foregoing, the third gas includes 0% to 15% by mol CO. In yet other embodiments, including any of the foregoing, the third gas includes 0% to 10% by mol CO. In still other embodiments, the third gas includes 0% by mol CO, 1% by mol CO, 2% by mol CO, 3% by mol CO, 4% by mol CO, 5% by mol CO, 6% by mol CO, 7% by mol CO, 8% by mol CO, 9% by mol CO, 10% by mol CO, 11% by mol CO, 12% by mol CO, 13% by mol CO, 14% by mol CO, 15% by mol CO, 16% by mol CO, 17% by mol CO, 18% by mol CO, 19% by mol CO, 20% by mol CO, 21% by mol CO, 22% by mol CO, 23% by mol CO, 24% by mol CO, 25% by mol CO, 26% by mol CO, 27% by mol CO, 28% by mol CO, 29% by mol CO, or 30% by mol CO. In some embodiments, including any of the foregoing, the third gas includes 0% by mol CO.

In some embodiments, including any of the foregoing, the process includes flowing the second gas from the main SOC stack to the thermochemical reactor. In some of these embodiments, a separation mechanism is used to separate CO₂ from the second gas prior to flowing the second gas from the main SOC stack to the thermochemical reactor. In certain of these embodiments, if separation occurs, a separate gas stream comprising primarily CO would be created that is directed back to the flow path of the second gas.

In some embodiments, including any of the foregoing, the first gas is provided by flowing CO₂ through the thermochemical reactor to react with carbon and form CO. Herein, this means that the first gas may be formed by flowing CO₂ into a thermochemical reactor, allowing the Boudouard reaction to occur in the thermochemical reactor, and flowing a combination of CO₂ and CO out of the thermochemical reactor.

In some embodiments, including any of the foregoing, the process includes compressing the third gas prior to storing the third gas.

In some embodiments, including any of the foregoing, the process includes compressing whatever gas is to be stored prior to storing that gas.

In some embodiments, including any of the foregoing, the process includes separating CO from CO₂ in the second gas, in the third gas, or both, using cryo-separation, a separating membrane, a pressure swing, a temperature swing, or a combination thereof. Separating membranes are commercially available, and include, but are not limited to, polymer-based, zeolite-based, silica-based or Metal-Organic Frameworks (MOFs) separating membranes. Any of these separation techniques may be used in isolation or in combination with any other separation techniques. For example, in one embodiment, the system may only include a pressure swing and/or a temperature swing for separating CO₂ from CO. In other embodiments, the system may only have cryoseparation. In still other embodiments, the system may include a membrane for separating CO₂ from CO. And in other embodiments, the system may include all of these separating mechanisms.

In other embodiments, the process or system may include any separating mechanism and may rely solely on the finishing stack, main stack, or both, to eliminate or reduce the partial pressure of CO in the gas stream that includes CO₂ and that is eventually stored in a CO₂ storage tank.

In some embodiments, including any of the foregoing, the separating produces a fourth gas that flows to thermochemical reactor; wherein the fourth gas has a higher pCO than the pCO in the second gas, in the third gas, or both. In certain embodiments, including any of the foregoing, the separating produces a fourth gas that flows to thermochemical reactor; wherein the fourth gas has a higher pCO than the pCO in the second gas. In certain other embodiments, including any of the foregoing, the separating produces a fourth gas that flows to thermochemical reactor; wherein the fourth gas has a higher pCO than the pCO in the third gas.

In some embodiments, including any of the foregoing, the separation increases the pCO₂ in the third gas prior to storing the third gas. In certain of these embodiments, the separation increases the pCO₂ in the third gas prior and produces a fourth gas that is stored in the CO₂ storage tank.

In some embodiments, including any of the foregoing, the closed loop does not include components for separating CO from CO₂ selected from at least one freezer, at least one membrane, at least one compressor pump, at least one cryogenic separator, or at least one pressure swing, or at least one temperature swing.

In some embodiments, including any of the foregoing, the main SOC stack, the finishing SOC stack, or both, individually in each instance includes one or more SOC stacks. Also contemplated herein are systems that include multiple stacks, and further in which each stack includes a series of cells. For example, there could be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 stacks. In some embodiments, there could be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 cells per each stack in either or both of the main stack or in the finishing stack. In these embodiments, each stack may include a series of cells, for example 1, 2, 3, 4, 5, 10, 15, 20, 25, 30, 40, 45, 50, 55, 60, 65, 70, 75, 80, 85, 90, 95, or 100 cells per stack.

In some embodiments, including any of the foregoing, the main SOC stack, the finishing SOC stack, or both, individually in each instance includes 1 to 250 SOCs.

In some embodiments, including any of the foregoing, the main SOC stack, the finishing SOC stack, or both, individually in each instance includes 1 to 260 SOCs.

In some embodiments, including any of the foregoing, the main SOC stack, the finishing SOC stack, or both, individually in each instance includes 1 to 300 SOCs.

In some embodiments, including any of the foregoing, there are three main stacks and one finishing stack.

In some embodiments, including any of the foregoing, there are ten main stacks and three finishing stacks.

In some embodiments, including any of the foregoing, there are fifty main stacks and five finishing stacks.

In some embodiments, including any of the foregoing, there are thirty main stacks and ten finishing stacks.

In some embodiments, including any of the foregoing, there are one-hundred main stacks and thirty finishing stacks.

In some embodiments, including any of the foregoing, there are five-hundred main stacks and fifty finishing stacks.

In some embodiments, including any of the foregoing, there are three-hundred main stacks and one-hundred finishing stacks.

In some embodiments, including any of the foregoing, there are one-thousand main stacks and three-hundred finishing stacks.

In some embodiments, including any of the foregoing, there are five-thousand main stacks and five-hundred finishing stacks.

In any of the above embodiments, each stack may include one to 300 cells [i.e., solid-oxide cells (SOC)] per stack.

In some embodiments, including any of the foregoing, the main SOC stack has more SOCs than the finishing SOC stack.

In some embodiments, including any of the foregoing, the closed loop constitutes a carbon-oxygen battery.

In some embodiments, including any of the foregoing, the main SOC stack provides the second gas below the Boudouard threshold. Herein, the Boudouard threshold is the partial pressure of CO (pCO) above which carbon is deposited and CO₂ is formed. The Boudouard threshold is also the partial pressure of CO₂ (pCO₂) above which Cis gasified and reacts with CO₂ to form CO.

In some embodiments, including any of the foregoing, the process includes operating the main SOC stack, the finishing stack, or both, individually in each instance at equal to, or greater than, 550° C. to less than, or equal to, 900° C. In certain of these embodiments, the main SOC stack operates at 550° C., 600° C., 650° C., 700° C., 750° C., 800° C., 850° C., or 900° C. In certain of these embodiments, the finishing SOC stack operates at 550° C., 600° C., 650° C., 700° C., 750° C., 800° C., 850° C., or 900° C.

In some embodiments, including any of the foregoing, the process includes operating the main SOC stack, the finishing stack, or both, individually in each instance at 750° C. or higher. In certain embodiments, the process includes operating the main SOC stack, the finishing stack, or both, individually in each instance at greater than, or equal to, 750° C. to less than, or equal to, 900° C.

In some embodiments, including any of the foregoing, the process includes operating the main SOC stack, the finishing stack, or both, individually in each instance at 750° C. or lower. In certain embodiments, the process includes operating the main SOC stack, the finishing stack, or both, individually in each instance at greater than, or equal to, 500° C. to less than, or equal to, 750° C.

In some embodiments, including any of the foregoing, the first gas flow rate in the finishing stack is lower than the first gas flow rate in the main stack. By flowing CO through the finishing stack at a lower rate than CO is flowed through the main stack, more of the CO is oxidized by the SOC.

In some embodiments, including any of the foregoing, the process includes applying a voltage of 0.5 V/cell to 1.215 V/cell in the finishing stack. In some of these embodiments, the finishing stack is at 600° C. In some other embodiments, the finishing stack is at 550° C., 600° C., 650° C., 700° C., 750° C., 800° C., 850° C., or 900° C.

In some embodiments, including any of the foregoing, the process includes applying a voltage of 0.9 V/cell in the finishing stack. In some of these embodiments, the finishing stack is at 600° C. In some other embodiments, the finishing stack is at 550° C., 600° C., 650° C., 700° C., 750° C., 800° C., 850° C., or 900° C.

In some embodiments, the finishing stack would have a lower voltage or a lower flow rate than the main stack.

In some other embodiments, the finishing stack would have the same voltage or flow rate than the main stack.

In some embodiments, including any of the foregoing, the finishing SOC stack can be part of the main SOC stack. In other embodiments, the main SOC stack can also be the finishing stack entirely.

In certain embodiments, including any of the foregoing, the finishing SOC stack operates at a different temperature than the main SOC stack.

In certain embodiments, including any of the foregoing, the finishing SOC stack operates at a different voltage than the main SOC stack.

In certain embodiments, including any of the foregoing, the finishing SOC stack has a different gas flow rate than the main SOC stack.

In certain embodiments, including any of the foregoing, the finishing SOC stack operates at the same temperature as the main SOC stack.

In certain embodiments, including any of the foregoing, the finishing SOC stack operates at the same voltage as the main SOC stack.

In certain embodiments, including any of the foregoing, the finishing SOC stack operates at the same flow rate as the main SOC stack.

### Sequential Use of a Main Solid-Oxide Cell Stack and a Finishing Solid-Oxide Cell Stack

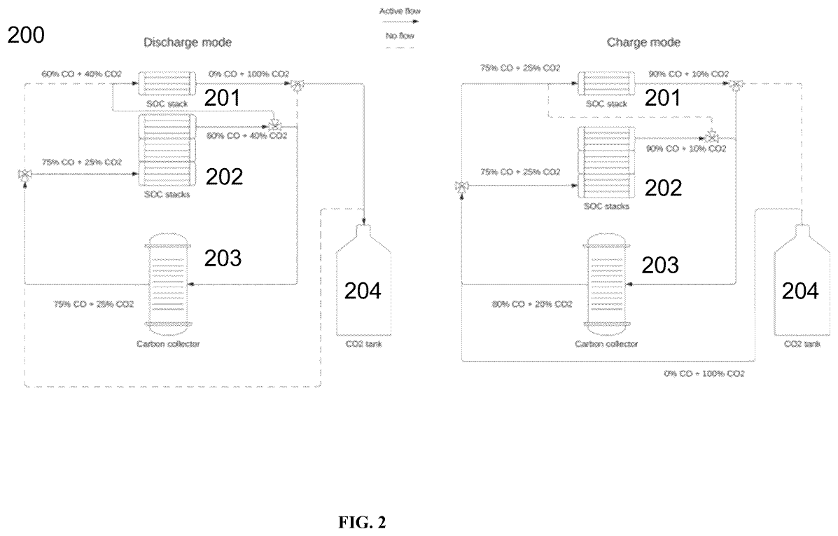

FIG. 2 shows an embodiment of a system for separating CO and CO₂. The system can operate in both discharge mode (shown on the left side) and in charged mode (shown on the right side). In the discharge mode, a carbon collector, 203, which is also referred to herein as a thermochemical reactor, produces a gas stream. In certain embodiments, this gas stream includes about 75% by mol CO and about 25% by mol CO₂. Percents herein are mole percents unless specified otherwise to the contrary. Depending on how the thermochemical reactor is operated, different percents of CO and CO₂ are possible. This gas stream that exits the thermochemical reactor flows to a main SOC stack (202) and then to a finishing SOC stack (201). In FIG. 2, the main SOC stack (202) is shown as having more total SOC stacks than the finishing SOC stack (201). The number of cells in each stack and the number of stacks in the main stack or in the finishing stack may vary. For example, the number of cells in each stack may range from 1 to 10 cells, from 1 to 250 cells, or 1 to 300 cells. The main stack may include more than 1 stack, for example, the main stack may include 1 to 10 stacks, wherein in stack may include 1 to 300 cells per stack. However, other embodiments are contemplated herein. The main SOC stack (202) and the finishing SOC stack (201) may have the same number of stacks or a different number of stacks. As shown in FIG. 2, the gas stream that includes about 75% by mol CO and about 25% by mol CO₂ flows to a main SOC stack (102) in which the CO is oxidized. This oxidation process also produces electricity in the main SOC stack (202) that can be used to run external devices. As the gas stream that flows into the main SOC stack (202), which is shown in FIG. 2 as including about 75% by mol CO and about 25% by mol CO₂, CO is oxidized to CO₂, and the main SOC stack (202) then produces a second gas stream that is shown in FIG. 2 as including about 60% by mol CO and about 40% by mol CO₂. Depending on how the main SOC stack (202) is operated, different percents of CO and CO₂ are possible. The gas stream that exits the main SOC stack (202) then flows to the finishing SOC stack (201). Depending on the actuation of certain valves, shown as triangles, the gas stream that exits the main SOC stack (202) may be directed back to the carbon collector reactor (203). As shown in FIG. 2, the gas stream that exits the main SOC stack (202), which is shown as having 60% by mol CO and 40% by mol CO₂, flows to the finishing SOC stack (201) in which the CO is oxidized. The conversion rate of CO to CO₂ in the finishing SOC stack (201) is higher than in the main stack. In some embodiments, this is because the flow rate in the finishing SOC stack (201) is lower than the flow rate in the main SOC stack (202). In some other embodiments, this is because of the voltage at which the finishing SOC stack (201) is operated. In certain embodiments, the finishing stack operates at be 0.05 V/cell, 0.1 V/cell, 0.15 V/cell, 0.2 V/cell, 0.25 V/cell, 0.3 V/cell, 0.35 V/cell, 0.4 V/cell, 0.45 V/cell or 0.5 V/cell lower voltage than the main stack. In some embodiments, the finishing SOC stack (201) oxidizes all of the CO in the portion of the gas stream that exits the main SOC stack (202) and that is shown in FIG. 2 as including about 60% by mol CO and about 40% by mol CO₂. In these embodiments, what exits the finishing SOC stack (201) is a gas stream that includes about 0% by mol CO and about 100% by mol CO₂. The gas stream that exits the finishing SOC stack (201), in discharge mode, has as lower pCO than the pCO in the gas stream that exits the main SOC stack (202). This third gas stream that exits the finishing SOC stack (201) is then stored in a CO₂ storage tank (204). In certain embodiments, the gas stream that exits the main SOC stack (202), which is shown in FIG. 2 as a gas stream that includes the about 60% by mol CO and about 40% by mol CO₂, flows back to the thermochemical reactor (203).

FIG. 2 shows on the right side how the immediately above process and system works under charging conditions. In charging mode, CO₂ exits or flows from the CO₂ storage tank (204). The CO₂ then flows to the main SOC (202) stack where electricity is supplied to the main SOC stack (202) to reduce the CO₂ and form CO. The CO₂ from the CO₂ tank may also flow to the finishing SOC (201) stack where electricity is supplied to the finishing SOC stack (201) to reduce the CO₂ and form CO. FIG. 2 shows that the gas that exits the main SOC stack (202) in charge mode includes about 90% by mol CO and 10% by mol CO₂. FIG. 2 also shows that the gas that exits the finishing SOC stack (201) in charge mode includes about 90% by mol CO and 10% by mol CO₂. Other percents of CO and CO₂ are possible depending on how the main SOC stack (202) and/or the finishing SOC stank (201) is operated. The gas stream that exits the main SOC stack (202) then flows to the carbon collector (203) where the Boudouard reaction occurs and the CO reacts to form solid C and generate CO₂. In some embodiments, what exits the carbon collector (203) is a gas that includes 80% by mol CO and 20% by mol CO₂. The gas stream that exits the finishing SOC stack (201) then flows to the carbon collector (203) where the Boudouard reaction occurs and the CO reacts to form solid C and more CO₂.

The numbers in FIG. 2 depend on how much gas is flowing from the carbon collector and from the CO₂ tank. If, for example, the gas stream coming from the carbon collector has many more molecules than the gas from the CO₂ tank, then a mixture of 80%/20% CO/CO₂, from the carbon collector, and 0%/100% CO/CO₂, from the CO₂ tank, can equal 75%/25% CO/CO₂, entering the SOC stacks. Different ratios are possible depending on how the reactors are operated.

In some embodiments, including any of the foregoing, set forth herein is a process that includes: flowing a first gas that comprises carbon monoxide (CO) and carbon dioxide (CO₂) to a main solid-oxide cell (SOC) stack; oxidizing the CO in the first gas in the main SOC stack to provide a second gas that comprises CO and CO₂ wherein the second gas has a lower partial pressure CO (pCO) than the first gas; flowing the second gas to a finishing SOC stack; and oxidizing the CO in the second gas in the finishing SOC to provide a third gas wherein the third gas has a lower pCO than the second gas.

In some embodiments, including any of the foregoing, the process includes storing the third gas.

In some embodiments, including any of the foregoing, the first gas is provided from a thermochemical reactor.

In some embodiments, including any of the foregoing, the main SOC stack, finishing SOC stack, and thermochemical reactor are in a closed loop.

In some embodiments, including any of the foregoing, the process includes a storage tank in the closed loop.

In some embodiments, including any of the foregoing, the first gas, second gas, and third gas flow in the closed loop.

In some embodiments, including any of the foregoing, the rate of storage of the third gas matches the rate of carbon gasification in the thermochemical reactor.

In some embodiments, including any of the foregoing, the first gas comprises 20% to 80% by mol CO; or 30% to 70% by mol CO. In certain embodiments, the first gas includes 20% by mol CO, 25% by mol CO, 30% by mol CO, 35% by mol CO, 40% by mol CO, 45% by mol CO, 50% by mol CO, 55% by mol CO, 60% by mol CO, 65% by mol CO, 70% by mol CO, 75% by mol CO, or 80% by mol CO. In certain other embodiments, the first gas includes 20% by mol CO, 21% by mol CO, 22% by mol CO, 23% by mol CO, 24% by mol CO, 25% by mol CO, 26% by mol CO, 27% by mol CO, 28% by mol CO, 29% by mol CO, 30% by mol CO, 31% by mol CO, 32% by mol CO, 33% by mol CO, 34% by mol CO, 35% by mol CO, 36% by mol CO, 37% by mol CO, 38% by mol CO, 39% by mol CO, 40% by mol CO, 41% by mol CO, 42% by mol CO, 43% by mol CO, 44% by mol CO, 45% by mol CO, 46% by mol CO, 47% by mol CO, 48% by mol CO, 49% by mol CO, 50% by mol CO, 51% by mol CO, 52% by mol CO, 53% by mol CO, 54% by mol CO, 55% by mol CO, 56% by mol CO, 57% by mol CO, 58% by mol CO, 59% by mol CO, 60% by mol CO, 61% by mol CO, 62% by mol CO, 63% by mol CO, 64% by mol CO, 65% by mol CO, 66% by mol CO, 67% by mol CO, 68% by mol CO, 69% by mol CO, 70% by mol CO, 71% by mol CO, 72% by mol CO, 73% by mol CO, 74% by mol CO, 75% by mol CO, 76% by mol CO, 77% by mol CO, 78% by mol CO, 79% by mol CO, or 80% by mol CO.

In some embodiments, including any of the foregoing, the third gas comprises at least 90% by mole (by mol) CO₂; 100% by mol CO₂; 0% to 30% by mol CO; 0% to 15% by mol CO; 0% to 10% by mol CO; 0% by mol CO; or a combination thereof.

In some embodiments, including any of the foregoing, the third gas includes 70% by volume (by mol) CO₂. In certain other embodiments, the third gas includes 70% by mol CO₂, 71% by mol CO₂, 72% by mol CO₂, 73% by mol CO₂, 74% by mol CO₂, 75% by mol CO₂, 76% by mol CO₂, 77% by mol CO₂, 78% by mol CO₂, 79% by mol CO₂, 80% by mol CO₂, 81% by mol CO₂, 82% by mol CO₂, 83% by mol CO₂, 84% by mol CO₂, 85% by mol CO₂, 86% by mol CO₂, 87% by mol CO₂, 88% by mol CO₂, 89% by mol CO₂, 90% by mol CO₂, 90% by mol CO₂, 91% by mol CO₂, 92% by mol CO₂, 93% by mol CO₂, 94% by mol CO₂, 95% by mol CO₂, 96% by mol CO₂, 97% by mol CO₂, 98% by mol CO₂, 99% by mol CO₂, or 100% by mol CO₂.

In some embodiments, including any of the foregoing, the third gas includes 0% to 30% by mol CO. In some other embodiments, including any of the foregoing, the third gas includes 0% to 15% by mol CO. In yet other embodiments, including any of the foregoing, the third gas includes 0% to 10% by mol CO. In still other embodiments, the third gas includes 0% by mol CO, 1% by mol CO, 2% by mol CO, 3% by mol CO, 4% by mol CO, 5% by mol CO, 6% by mol CO, 7% by mol CO, 8% by mol CO, 9% by mol CO, 10% by mol CO, 11% by mol CO, 12% by mol CO, 13% by mol CO, 14% by mol CO, 15% by mol CO, 16% by mol CO, 17% by mol CO, 18% by mol CO, 19% by mol CO, 20% by mol CO, 21% by mol CO, 22% by mol CO, 23% by mol CO, 24% by mol CO, 25% by mol CO, 26% by mol CO, 27% by mol CO, 28% by mol CO, 29% by mol CO, or 30% by mol CO. In some embodiments, including any of the foregoing, the third gas includes 0% by mol CO.

In some embodiments, including any of the foregoing, the process includes flowing the second gas from the main SOC stack to the thermochemical reactor.

In some embodiments, including any of the foregoing, the second gas reacts in the thermochemical reactor to deposit carbon and produce CO₂.

In some embodiments, including any of the foregoing, the first gas is provided by flowing CO₂ through the thermochemical reactor to react with carbon and form CO.

In some embodiments, including any of the foregoing, the process includes compressing the third gas prior to storing the third gas.

In some embodiments, including any of the foregoing, the process includes compressing whatever gas is to be stored prior to storing that gas.

In some embodiments, including any of the foregoing, the process includes separating CO from CO₂ in the second gas, in the third gas, or both, using cryo-separation, a separating membrane, a pressure swing, a temperature swing, or a combination thereof.

In some embodiments, including any of the foregoing, the separating increases the pCO₂ in the third gas prior to storing the third gas.

In some embodiments, including any of the foregoing, the closed loop does not comprise components for separating CO from CO₂ selected from at least one freezer, at least one membrane, at least one compressor pump, at least one cryogenic separator, at least one pressure swing, or at least one temperature swing.

In some embodiments, including any of the foregoing, the main SOC stack, the finishing SOC stack, or both, individually in each instance includes one or more SOC stacks. Also contemplated herein are systems that include multiple stacks, and further in which each stack includes a series of cells. For example, there could be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 stacks. In these embodiments, each stack may include a series of cells, for example 5, 10, 15, 20, 25, 30, 40, 45, 50, 55, 60, 65, 70, 75, 80, 85, 90, 95, or 100 cells per stack.

In some embodiments, including any of the foregoing, the main SOC stack, the finishing SOC stack, or both, individually in each instance comprises 1 to 250 SOCs.

In some embodiments, including any of the foregoing, the main SOC stack has more SOCs than the finishing SOC stack.

In some embodiments, including any of the foregoing, the closed loop constitutes a carbon-oxygen battery.

In some embodiments, including any of the foregoing, the main SOC stack provides the second gas below the Boudouard threshold.

In some embodiments, including any of the foregoing, the process includes operating the main SOC stack, the finishing stack, or both, individually in each instance at equal to, or greater than, 600° C. to less than, or equal to, 800° C.

In some embodiments, including any of the foregoing, the process includes operating the main SOC stack, the finishing stack, or both, individually in each instance at equal to, or greater than, 550° C. to less than, or equal to, 900° C. In certain of these embodiments, the main SOC stack operates at 550° C., 600° C., 650° C., 700° C., 750° C., 800° C., 850° C., or 900° C. In certain of these embodiments, the finishing SOC stack operates at 550° C., 600° C., 650° C., 700° C., 750° C., 800° C., 850° C., or 900° C.

In some embodiments, including any of the foregoing, the process includes operating the main SOC stack, the finishing stack, or both, individually in each instance at 750° C. or higher.

In some embodiments, including any of the foregoing, the process includes operating the main SOC stack, the finishing stack, or both, individually in each instance at 750° C. or higher. In certain embodiments, the process includes operating the main SOC stack, the finishing stack, or both, individually in each instance at greater than, or equal to, 750° C. to less than, or equal to, 900° C.

In some embodiments, including any of the foregoing, the process includes operating the main SOC stack, the finishing stack, or both, individually in each instance at 750° C. or lower.

In some embodiments, including any of the foregoing, the process includes operating the main SOC stack, the finishing stack, or both, individually in each instance at 750° C. or lower. In certain embodiments, the process includes operating the main SOC stack, the finishing stack, or both, individually in each instance at greater than, or equal to, 500° C. to less than, or equal to, 750° C.

In some embodiments, including any of the foregoing, the first gas flow rate in the finishing stack is lower than the first gas flow rate in the main stack.

In some embodiments, including any of the foregoing, the process includes applying a voltage of 0.9 V/cell or from 0.5 V/cell to 1.215 V/cell or current bias in the finishing stack; optionally wherein the finishing stack is at 600° C.

In some embodiments, including any of the foregoing, the process includes applying a voltage of 0.5 V/cell to 1.215 V/cell in the finishing stack. In some of these embodiments, the finishing stack is at 600° C. In some other embodiments, the finishing stack is at 550° C., 600° C., 650° C., 700° C., 750° C., 800° C., 850° C., or 900° C.

In some embodiments, including any of the foregoing, the process includes applying a voltage of 0.9 V/cell in the finishing stack. In some of these embodiments, the finishing stack is at 600° C. In some other embodiments, the finishing stack is at 550° C., 600° C., 650° C., 700° C., 750° C., 800° C., 850° C., or 900° C.

In some embodiments, including any of the foregoing, the finishing SOC stack can be part of the main SOC stack. In other embodiments, the main SOC stack can also be the finishing stack entirely.

In certain embodiments, including any of the foregoing, the finishing SOC stack operates at a different temperature than the main SOC stack.

In certain embodiments, including any of the foregoing, the finishing SOC stack operates at a different voltage than the main SOC stack.

In certain embodiments, including any of the foregoing, the finishing SOC stack has a different gas flow rate than the main SOC stack.

In certain embodiments, including any of the foregoing, the finishing SOC stack operates at the same temperature as the main SOC stack.

In certain embodiments, including any of the foregoing, the finishing SOC stack operates at the same voltage as the main SOC stack.

In certain embodiments, including any of the foregoing, the finishing SOC stack operates at the same flow rate as the main SOC stack.

### Use of Only a Main Solid-Oxide Cell Stack

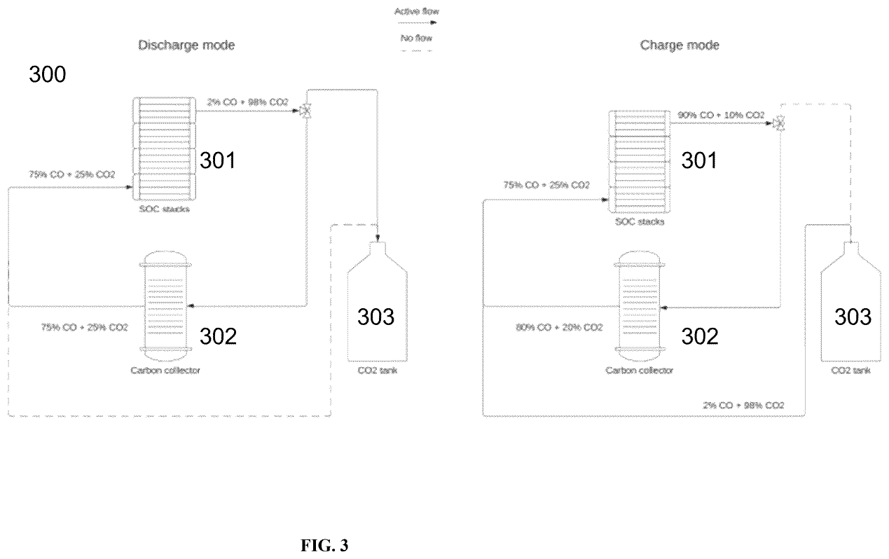

Also contemplated herein are processes and systems that use only a main SOC stack, for example, as shown in FIG. 3.

In FIG. 3, discharge mode is shown on the left side and the charge mode is shown on the right side.

In the discharge mode, a carbon collector reactor (302), which is also referred to herein as a thermochemical reactor, produces a gas stream. In certain embodiments, this gas stream includes about 75% by mole (by mol) CO and about 25% by mol CO₂. Percents herein are mole percents unless specified otherwise to the contrary. Depending on how the thermochemical reactor is operated, different percents of CO and CO₂ are possible. This gas stream that exits the thermochemical reactor flows to a main solid-oxide cell (SOC) stack (301). As shown in FIG. 3, the gas stream that includes about 75% by mol CO and about 25% by mol CO₂ flows to a main SOC stack (301) in which the CO is oxidized. This oxidation process also produces electricity in the main SOC stack (301) that can be used to run external devices. As the gas stream that includes about 75% by mol CO and about 25% by mol CO₂ is oxidized, the main SOC stack (301) then produces a second gas stream that includes about 2% by mol CO and about 98% by mol CO₂—the so-called second gas stream. Depending on how the main SOC stack (301) is operated, different percents of CO and CO₂ are possible. In some embodiments, the main SOC stack (301) oxidizes all of the CO in the portion of the gas stream from the thermochemical reactor, e.g., the gas stream in FIG. 3 that includes about 75% by mol CO and about 25% by mol CO₂. In these embodiments, what exits the main SOC stack (301) is a gas stream that includes 0% by mol CO and 100% by mol CO₂. This gas stream that exits the main SOC stack (301) is then stored in a CO₂ storage tank (303). In certain embodiments, the gas stream that exits the main SOC stack, which is shown in FIG. 3 as a gas stream that includes the about 2% by mol CO and about 98% by mol CO₂, flows back to the thermochemical reactor (302).

In some other embodiments, gas stream that includes the about 2% by mol CO and about 98% by mol CO₂ is sent to a separation mechanism that separates CO₂ and flows this separated CO₂ into the CO₂ storage tank (303). This separation process is not shown in FIG. 3 but is contemplated herein.

In FIG. 3, the triangle shapes represent valves and connections between gas conduit lines. These valves may be opened or closed to adjust the flow paths shown in FIG. 3.

FIG. 3 shows on the right side how the immediately above process and system works under charging conditions. In charging mode, CO₂ exits or flows from the CO₂ storage tank (303). The CO₂ then flows to the main SOC (301) stack where electricity is supplied to the main SOC stack (301) to reduce the CO₂ and form CO. FIG. 3 shows that the gas that exits the main SOC stack (301) in charge mode includes about 90% by mol CO and 10% by mol CO₂. Other percents of CO and CO₂ are possible depending on how the main SOC stack (301) is operated. The gas stream that exits the main SOC stack (301) then flows to the carbon collector (302) where the Boudouard reaction occurs and the CO reacts to form solid C and generate CO₂. What exits the carbon collector (302) has more CO than the gas that flows from the CO₂ tank. In some embodiments, the gas that exits the carbon collector (302) includes about 80% by mol CO and 20% by mol CO₂.

The numbers in FIG. 3 depend on how much gas is flowing from the carbon collector and from the CO₂ tank. If, for example, the gas stream coming from the carbon collector has many more molecules than the gas from the CO₂ tank, then a mixture of 80%/20% CO/CO₂, from the carbon collector, and 2%/98% CO/CO₂, from the CO₂ tank, can equal 75%/25% CO/CO₂, entering the SOC stacks. Different ratios are possible depending on how the reactors are operated.

When the system in FIG. 3 operates in charge mode, electricity is supplied to the main SOC stack (301) as compared to the above-described discharge mode in which electricity is produced from the main stack. When the main SOC stack (301) is supplied electricity, CO₂ is reduced to form CO. When the main SOC stack (301) produces electricity, CO is oxidized to form CO₂. During charge mode, CO reacts in the thermochemical reactor to deposit carbon and produce CO₂. During discharge mode, CO₂ reacts in the thermochemical reactor with carbon to produce CO.

In some embodiments, set forth herein is a process that includes: flowing a first gas that comprises carbon monoxide (CO) and carbon dioxide (CO₂) to a solid-oxide cell (SOC) stack; oxidizing the CO in the first gas in the SOC stack to provide a second gas that comprises CO and CO₂ wherein the second gas has a lower partial pressure CO (pCO) than the first gas; separating the second gas into a third gas and a fourth gas; wherein the fourth gas has a lower partial pressure CO (pCO) than the third gas; flowing third gas to a thermochemical reactor; and storing the fourth gas.

In some embodiments, including any of the foregoing, the process includes storing the third gas.

In some embodiments, including any of the foregoing, the first gas is provided from a thermochemical reactor.

In some embodiments, including any of the foregoing, the SOC stack, thermochemical reactor, and a storage tank are in a closed loop.

In some embodiments, including any of the foregoing, the first gas, second gas, third gas and fourth gas, flow in the closed loop.

In some embodiments, including any of the foregoing, the rate of storage of the fourth gas matches the rate of carbon gasification in the thermochemical reactor.

In some embodiments, including any of the foregoing, the first gas comprises 20% to 80% by mol CO; or 30% to 70% by mol CO. In certain embodiments, the first gas includes 20% by mol CO, 25% by mol CO, 30% by mol CO, 35% by mol CO, 40% by mol CO, 45% by mol CO, 50% by mol CO, 55% by mol CO, 60% by mol CO, 65% by mol CO, 70% by mol CO, 75% by mol CO, or 80% by mol CO. In certain other embodiments, the first gas includes 20% by mol CO, 21% by mol CO, 22% by mol CO, 23% by mol CO, 24% by mol CO, 25% by mol CO, 26% by mol CO, 27% by mol CO, 28% by mol CO, 29% by mol CO, 30% by mol CO, 31% by mol CO, 32% by mol CO, 33% by mol CO, 34% by mol CO, 35% by mol CO, 36% by mol CO, 37% by mol CO, 38% by mol CO, 39% by mol CO, 40% by mol CO, 41% by mol CO, 42% by mol CO, 43% by mol CO, 44% by mol CO, 45% by mol CO, 46% by mol CO, 47% by mol CO, 48% by mol CO, 49% by mol CO, 50% by mol CO, 51% by mol CO, 52% by mol CO, 53% by mol CO, 54% by mol CO, 55% by mol CO, 56% by mol CO, 57% by mol CO, 58% by mol CO, 59% by mol CO, 60% by mol CO, 61% by mol CO, 62% by mol CO, 63% by mol CO, 64% by mol CO, 65% by mol CO, 66% by mol CO, 67% by mol CO, 68% by mol CO, 69% by mol CO, 70% by mol CO, 71% by mol CO, 72% by mol CO, 73% by mol CO, 74% by mol CO, 75% by mol CO, 76% by mol CO, 77% by mol CO, 78% by mol CO, 79% by mol CO, or 80% by mol CO.

In some embodiments, including any of the foregoing, the fourth gas comprises at least 90% by mole (by mol) CO₂; 100% by mol CO₂; 0% to 30% by mol CO; 0% to 15% by mol CO; 0% to 10% by mol CO; or 0% by mol CO; or a combination thereof.

In some embodiments, including any of the foregoing, the fourth gas comprises 90% by mol CO₂, 90% by mol CO₂, 91% by mol CO₂, 92% by mol CO₂, 93% by mol CO₂, 94% by mol CO₂, 95% by mol CO₂, 96% by mol CO₂, 97% by mol CO₂, 98% by mol CO₂, 99% by mol CO₂, or 100% by mol CO₂. In some of these embodiments, the fourth gas comprises 0% by mol CO, 1% by mol CO, 2% by mol CO, 3% by mol CO, 4% by mol CO, 5% by mol CO, 6% by mol CO, 7% by mol CO, 8% by mol CO, 9% by mol CO, or 10% by mol CO.

In some embodiments, including any of the foregoing, the third gas reacts in the thermochemical reactor to deposit carbon and produce CO₂.

In some embodiments, including any of the foregoing, the first gas is provided by flowing CO₂ through the thermochemical reactor to react with carbon and form CO.

In some embodiments, including any of the foregoing, the process includes compressing the fourth gas prior to storing the fourth gas.

In some embodiments, including any of the foregoing, the process includes compressing whatever gas is to be stored prior to storing that gas.

In some embodiments, including any of the foregoing, the process includes separating CO from CO₂ in the second gas, in the fourth gas, or both, using cryo-separation, a separating membrane, a pressure swing, a temperature swing, or a combination thereof. Any of these separation techniques may be used in isolation or in combination with any other separation techniques. For example, in one embodiment, the system may only include a pressure swing and/or a temperature swing for separating CO₂ from CO. In other embodiments, the system may only have cryoseparation. In still other embodiments, the system may include a membrane for separating CO₂ from CO. And in other embodiments, the system may include all of these separating mechanisms.

In some embodiments, including any of the foregoing, the separating increases the pCO₂ in the fourth gas prior to storing the fourth gas.

In some embodiments, including any of the foregoing, the closed loop constitutes a carbon-oxygen battery.

In some embodiments, including any of the foregoing, the SOC stack provides the second gas below the Boudouard threshold.

In some embodiments, including any of the foregoing, the process includes operating the SOC stack at equal to, or greater than, 600° C. to less than, or equal to, 800° C.

In some embodiments, including any of the foregoing, the process includes operating the SOC stack at 750° C. or higher.

In some embodiments, including any of the foregoing, the process includes operating the SOC stack at 750° C. or lower.

In some embodiments, including any of the foregoing, the process includes operating the SOC stack at equal to, or greater than, 550° C. to less than, or equal to, 900° C. In certain of these embodiments, the main SOC stack operates at 550° C., 600° C., 650° C., 700° C., 750° C., 800° C., 850° C., or 900° C. In certain of these embodiments, the SOC stack operates at 550° C., 600° C., 650° C., 700° C., 750° C., 800° C., 850° C., or 900° C.

In some embodiments, including any of the foregoing, the process includes operating the SOC stack at 750° C. or higher. In certain embodiments, the process includes operating the SOC stack at greater than, or equal to, 750° C. to less than, or equal to, 900° C.

In some embodiments, including any of the foregoing, the process includes operating the SOC stack at 750° C. or lower. In certain embodiments, the process includes operating the SOC stack at greater than, or equal to, 500° C. to less than, or equal to, 750° C.

In some embodiments, including any of the foregoing, the process includes applying a voltage of 0.5 V/cell to 1.215 V/cell in the SOC stack. In some of these embodiments, the SOC stack is at 600° C. In some other embodiments, the SOC stack is at 550° C., 600° C., 650° C., 700° C., 750° C., 800° C., 850° C., or 900° C.

In some embodiments, including any of the foregoing, the process includes applying a voltage of 0.9 V/cell in the SOC stack. In some of these embodiments, the SOC stack is at 600° C. In some other embodiments, the SOC stack is at 550° C., 600° C., 650° C., 700° C., 750° C., 800° C., 850° C., or 900° C.

In some embodiments, including any of the foregoing, the flow may be a passive flow in which no external energy is used to assist the flow of gas. In some other embodiments, the flow may be active. When active, the flow may be assisted or provided by using pumps, compressors, vacuum systems, or a combination thereof.

### EXAMPLES

Instruments were a custom built solid oxide stack testing rig that included several Nova 7900P gas analyzers, and a BioLogic potentiostat/galvanostat SP-150 with VSP and VMP3 booster.

### Example 1

A solid oxide cell stack was prepared. The reaction occurred at 600° C.-800° C.

The aforementioned stack was run to fully convert CO to CO₂, periodically checking OCV and performing EIS to determine the degree of degradation.

The stack was also cycled at a lower overpotential in order to not fully convert CO to CO₂, so pCO (CO concentration in balance CO₂) flowing out of the stack was greater than 0% in the middle of the run in order to differentiate between degradation from full conversion to CO₂ and degradation from time/normal use.

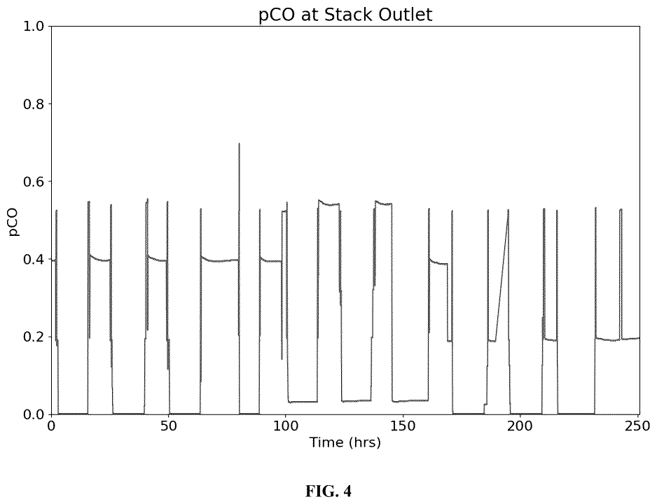

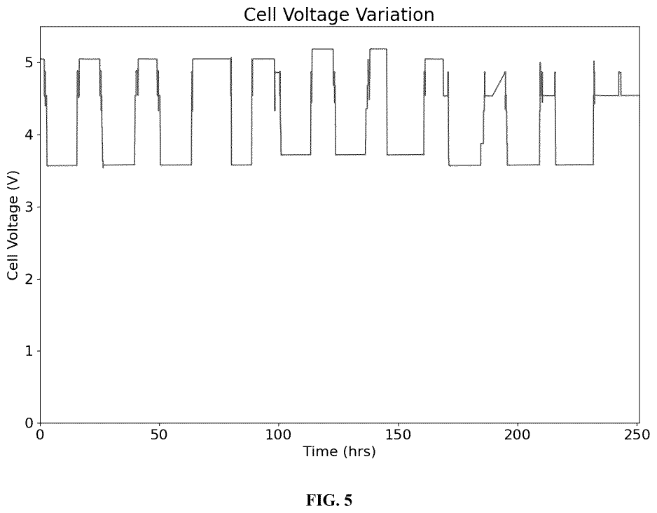

FIGS. 4-5 show the results over the course of the experiment. Cell voltage varied over the course of the experiment to alter pCO of an inlet stream with 20% pCO concentration, cycling between a high pCO setpoint (40%-50%, using SOEC-mode operation) and a low pCO setpoint (0%-5%, using SOFC-mode operation). Throughout the experiment, pCO was occasionally set at 20% and 50% to measure OCV and EIS, respectively, to benchmark stack degradation.

From time=~100 hours to time=~175 hours, full conversion to CO₂ did not happen (reflected in both the left and right graph) in order to differentiate between degradation from full conversion to CO₂ and “normal” degradation.

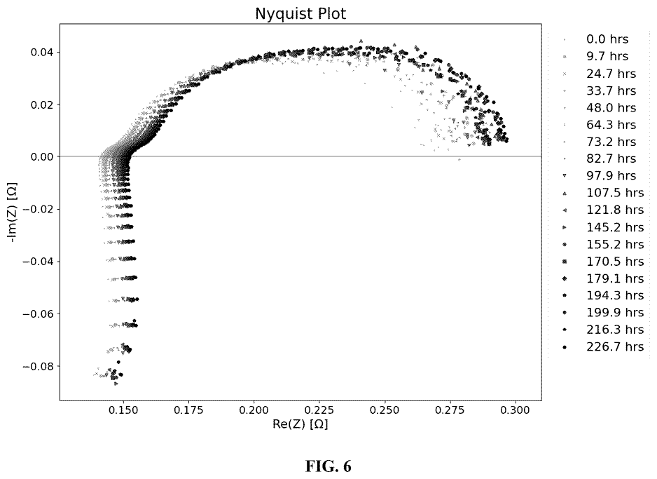

FIG. 6 shows a collection of Nyquist plots that show the change in resistance over time. Ohmic resistance and total Area-Specific Resistance (ASR) gradually but consistently increase over the course of the experiment. Lighter colors were the first EIS runs and darker colors occurred later.

The following Table shows the Ohmic resistance and ASR as extracted from the Nyquist plot series in FIG. 6.

| | Ohmic Resistance | Total Resistance | | |
|---|---|---|---|---|
| Time (hrs) | (ohm) | (ohm) | Ohmic Deviation (%) | Total Deviation (%) |
| 0.00 | 0.14 | 0.27 | 0.00 | 0.00% |
| 9.68 | 0.14 | 0.28 | 1.66 | 5.26% |
| 24.72 | 0.14 | 0.27 | 1.10 | 1.27% |
| 33.70 | 0.14 | 0.28 | 2.15 | 4.69% |
| 47.95 | 0.14 | 0.27 | 1.96 | 1.94% |
| 64.30 | 0.15 | 0.29 | 3.83 | 7.70% |
| 73.15 | 0.15 | 0.28 | 2.86 | 3.07% |
| 82.72 | 0.15 | 0.29 | 4.25 | 7.44% |
| 97.87 | 0.15 | 0.28 | 3.78 | 4.91% |
| 107.55 | 0.15 | 0.29 | 4.93 | 9.08% |
| 121.77 | 0.15 | 0.29 | 5.25 | 6.93% |
| 145.20 | 0.15 | 0.29 | 5.68 | 7.06% |
| 155.17 | 0.15 | 0.30 | 6.44 | 9.69% |
| 170.47 | 0.15 | 0.29 | 6.38 | 7.67% |
| 179.08 | 0.15 | 0.29 | 6.92 | 9.47% |
| 194.30 | 0.15 | 0.29 | 6.44 | 7.80% |
| 199.88 | 0.15 | 0.30 | 7.35 | 10.31% |
| 216.33 | 0.15 | 0.29 | 6.89 | 7.68% |
| 226.70 | 0.15 | 0.30 | 7.94 | 10.19% |
| 243.08 | 0.15 | 0.30 | 8.24 | 10.96% |

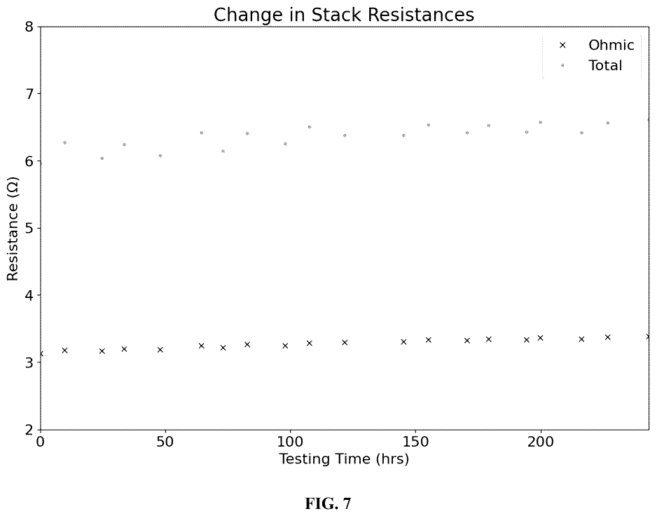

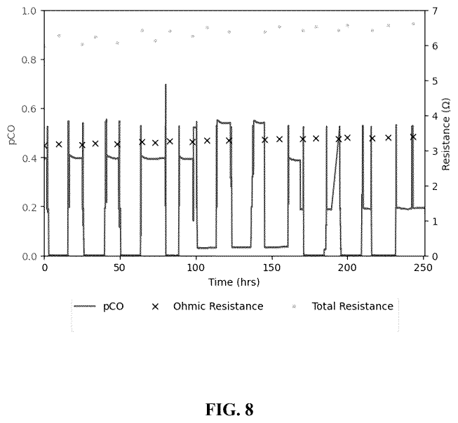

FIGS. 7-8 show the same data in graphical format.

FIG. 8 shows a summary plot detailing the increase in resistance during cycling. In FIG. 8, the degradation rate appears constant throughout the course of the experiment, even when full CO₂ conversion did not occur. This indicates that the stack can operate at full conversion to CO₂ without additional degradation.

The Nyquist plot shows cell resistance (computation based on where it intercepts the x-axis). Cell resistances are plotted on the following graph.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

1. A process comprising:
flowing a first gas that comprises carbon monoxide (CO) and carbon dioxide (CO₂) to a main solid-oxide cell (SOC) stack;
oxidizing the CO in the first gas in the main SOC stack to provide a second gas that comprises CO and CO₂ wherein the second gas has a lower partial pressure of CO (pCO) than the first gas; and
flowing the first gas to a finishing SOC stack;
oxidizing the CO in the first gas in the finishing SOC to provide a third gas wherein the third gas has a lower pCO than the second gas.

2. The process of claim 1, further comprising storing the third gas.

3. The process of claim 1 or 2, wherein the first gas is provided from a thermochemical reactor.

4. The process of any one of claims 1-3, wherein the main SOC stack, finishing SOC stack, and thermochemical reactor are in a closed loop.

5. The process of claim 4, further comprising a storage tank in the closed loop.

6. The process of any one of claims 4-5, wherein the first gas, second gas, and third gas flow in the closed loop.

7. The process of any one of claims 3-5, wherein the rate of storage of the third gas matches a rate of carbon gasification in the thermochemical reactor.

8. The process of any one of claims 1-7, wherein the first gas comprises 20% to 80% by mol CO.

9. The process of any one of claims 1-8, wherein the first gas comprises 30% to 70% by mol CO.

10. The process of any one of claims 1-9, wherein the third gas comprises at least 70% by mol CO₂.

11. The process of any one of claims 1-10, wherein the third gas comprises at least 80% by mol CO₂.

12. The process of any one of claims 1-11, wherein the third gas comprises at least 90% by mol CO₂.

13. The process of any one of claims 1-12, wherein the third gas consists of 100% by mol CO₂.

14. The process of any one of claims 1-13, wherein the third gas comprises 0% to 30% by mol CO.

15. The process of any one of claims 1-14, wherein the third gas comprises 0% to 15% by mol CO.

16. The process of any one of claims 1-15, wherein the third gas comprises 0% to 10% by mol CO.

17. The process of any one of claims 1-16, wherein the third gas comprises 0% by mol CO.

18. The process of any one of claims 3-17, further comprising flowing the second gas from the main SOC stack to the thermochemical reactor.

19. The process of any one of claims 3-18, wherein the first gas is provided by flowing CO₂ through the thermochemical reactor to react with carbon and form CO.

20. The process of any one of claims 1-19, comprising compressing the third gas prior to storing the third gas.

21. The process of any one of claims 1-20, comprising separating CO from CO₂ in the second gas, in the third gas, or both, using cryo-separation, a separating membrane, a pressure swing, a temperature swing, or a combination thereof.

22. The process of claim 21, wherein the separating produces a fourth gas that flows to thermochemical reactor; wherein the fourth gas has a higher pCO than the pCO in the second gas, in the third gas, or both.

23. The process of claim 21 or 22, wherein the separation increases the pCO₂ in the third gas prior to storing the third gas.

24. The process of any one of claims 4-20, wherein the closed loop does not comprise components for separating CO from CO₂ selected from at least one freezer, at least one membrane, at least one compressor pump, at least one cryogenic separator, or at least one pressure, at least one temperature swing.

25. The process of any one of claims 1-24, wherein the main SOC stack, the finishing SOC stack, or both, individually in each instance comprises 1 to 250 SOCs.

26. The process of any one of claims 1-25, wherein the main SOC stack has more SOCs than the finishing SOC stack.

27. The process of any one of claims 4-26, wherein the closed loop constitutes a carbon-oxygen battery.

28. The process of any one of claims 1-27, wherein the main SOC stack provides the second gas below the Boudouard threshold.

29. The process of any one of claims 1-28, comprising operating the main SOC stack, the finishing stack, or both, individually in each instance at equal to, or greater than, 550° C. to less than, or equal to, 900° C.

30. The process of any one of claims 1-29, comprising operating the main SOC stack, the finishing stack, or both, individually in each instance at 750° C. or higher.

31. The process of any one of claims 1-29, comprising operating the main SOC stack, the finishing stack, or both, individually in each instance at 750° C. or lower.

32. The process of any one of claims 1-31, wherein the first gas flow rate in the finishing stack is lower than the first gas flow rate in the main stack.

33. The process of any one of claims 1-32, comprising applying a voltage of 0.5 V/cell to 1.215 V/cell in the finishing stack; optionally wherein the finishing stack is at 600° C.

34. The process of any one of claims 1-33, comprising applying a voltage of 0.9 V/cell in the finishing stack; optionally wherein the finishing stack is at 600° C.

35. A process comprising:
flowing a first gas that comprises carbon monoxide (CO) and carbon dioxide (CO₂) to a main solid-oxide cell (SOC) stack;
oxidizing the CO in the first gas in the main SOC stack to provide a second gas that comprises CO and CO₂ wherein the second gas has a lower partial pressure CO (pCO) than the first gas;
flowing the second gas to a finishing SOC stack; and
oxidizing the CO in the second gas in the finishing SOC to provide a third gas wherein the third gas has a lower pCO than the second gas.

36. The process of claim 35, further comprising storing the third gas.

37. The process of claim 35 or 36, wherein the first gas is provided from a thermochemical reactor.

38. The process of claim 37, wherein the main SOC stack, finishing SOC stack, and thermochemical reactor are in a closed loop.

39. The process of claim 38, further comprising a storage tank in the closed loop.

40. The process of any one of claims 38-39, wherein the first gas, second gas, and third gas flow in the closed loop.

41. The process of any one of claims 35-40, wherein the rate of storage of the third gas matches a rate of carbon gasification in the thermochemical reactor.

42. The process of any one of claims 35-41, wherein the first gas comprises 20% to 80% by mol CO; or 30% to 70% by mol CO.

43. The process of any one of claims 35-42, wherein the third gas comprises at least 90% by mole (by mol) CO₂; 100% by mol CO₂; 0% to 30% by mol CO; 0% to 15% by mol CO; 0% to 10% by mol CO; 0% by mol CO; or a combination thereof.

44. The process of any one of claims 35-43, further comprising flowing the second gas from the main SOC stack to the thermochemical reactor.

45. The process of any one of claims 35-44, wherein the first gas is provided by flowing CO₂ through the thermochemical reactor to react with carbon and form CO.

46. The process of any one of claims 35-45, comprising compressing the third gas prior to storing the third gas.

47. The process of any one of claims 35-46, comprising separating CO from CO₂ in the second gas, in the third gas, or both, using cryo-separation, a separating membrane, a pressure swing, a temperature swing, or a combination thereof.

48. The process of claim 47, wherein the separating increases the pCO₂ in the third gas prior to storing the third gas.

49. The process of any one of claims 38-46, wherein the closed loop does not comprise components for separating CO from CO₂ selected from at least one freezer, at least one membrane, at least one compressor pump, at least one cryogenic separator, at least one pressure swing, or at least one temperature swing.

50. The process of any one of claims 35-49, wherein the main SOC stack, the finishing SOC stack, or both, individually in each instance comprises 1 to 250 SOCs.

51. The process of any one of claims 35-50, wherein the main SOC stack has more SOCs than the finishing SOC stack.

52. The process of any one of claims 38-51, wherein the closed loop constitutes a carbon-oxygen battery.

53. The process of any one of claims 35-52, wherein the main SOC stack provides the second gas below the Boudouard threshold.

54. The process of any one of claims 35-53, comprising operating the main SOC stack, the finishing stack, or both, individually in each instance at equal to, or greater than, 600° C. to less than, or equal to, 800° C.

55. The process of any one of claims 35-53, comprising operating the main SOC stack, the finishing stack, or both, individually in each instance at 750° C. or higher.

56. The process of any one of claims 35-53, comprising operating the main SOC stack, the finishing stack, or both, individually in each instance at 750° C. or lower.

57. The process of any one of claims 35-56, wherein the first gas flow rate in the finishing stack is lower than the first gas flow rate in the main stack.

58. The process of any one of claims 35-57, comprising apply a voltage of 0.9 V/cell or from 0.5 V/cell to 1.215 V/cell or current bias in the finishing stack; optionally wherein the finishing stack is at 600° C.

59. A process comprising:
flowing a first gas that comprises carbon monoxide (CO) and carbon dioxide (CO₂) to a solid-oxide cell (SOC) stack;
oxidizing the CO in the first gas in the SOC stack to provide a second gas that comprises CO and CO₂ wherein the second gas has a lower partial pressure CO (pCO) than the first gas;
separating the second gas into a third gas and a fourth gas;
wherein the fourth gas has a lower partial pressure CO (pCO) than the third gas;
flowing the third gas to a thermochemical reactor; and
storing the fourth gas.

60. The process of claim 59, further comprising storing the third gas.

61. The process of claim 59 or 60, wherein the first gas is provided from a thermochemical reactor.

62. The process of any one of claims 59-61, wherein the SOC stack, thermochemical reactor, and a storage tank are in a closed loop.

63. The process of claim 62, wherein the first gas, second gas, third gas and fourth gas, flow in the closed loop.

64. The process of any one of claims 59-63, wherein the rate of storage of the fourth gas matches a rate of carbon gasification in the thermochemical reactor.

65. The process of any one of claims 59-64, wherein the first gas comprises 20% to 80% by mol CO; or 30% to 70% by mol CO.

66. The process of any one of claims 59-65, wherein the fourth gas comprises at least 90% by mole (by mol) CO₂; 100% by mol CO₂; 0% to 30% by mol CO; 0% to 15% by mol CO; 0% to 10% by mol CO; 0% by mol CO; or a combination thereof.

67. The process of any one of claims 59-66, wherein the first gas is provided by flowing CO₂ through the thermochemical reactor to react with carbon and form CO.

68. The process of any one of claims 59-67, comprising compressing the fourth gas prior to storing the fourth gas.

69. The process of any one of claims 59-68, comprising separating CO from CO₂ in the second gas, in the fourth gas, or both, using cryo-separation, a separating membrane, a pressure swing, a temperature swing, or a combination thereof.

70. The process of claim 69, wherein the separating increases the pCO₂ in the fourth gas prior to storing the fourth gas.

71. The process of any one of claims 62-70, wherein the closed loop constitutes a carbon-oxygen battery.

72. The process of any one of claims 59-71, wherein the SOC stack provides the second gas below the Boudouard threshold.

73. The process of any one of claims 59-72, comprising operating the SOC stack at equal to, or greater than, 600° C. to less than, or equal to, 800° C.

74. The process of any one of claims 59-73, comprising operating the SOC stack at 750° C. or higher.

75. The process of any one of claims 59-73, comprising operating the SOC stack at 750° C. or lower.
